(19) United States
(12) Patent Application Publication
(10) Pub. No.: US 2006/0265752 A1
(43) Pub. Date: Nov. 23, 2006

(54) Method and system for authentificating a disc

(75) Inventors: Gongming Wei, Shanghai (CN); Bei Wang, Shanghai (CN); Wenying You, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA Eindhoven (NL)

(21) Appl. No.: 10/546,708

(22) PCT Filed: Dec. 2, 2003
(86) PCT No.: PCT/IB03/05735

§ 371 Date: Mar. 13, 2006

(30) Foreign Application Priority Data
Dec. 23, 2002 (CN) 02157874.5

(51) Int. Cl. H04N 7/16

(52) U.S. Cl. 726/26

(57) ABSTRACT

The present invention provides a disc player that authenticates a disc via the Internet. According to one embodiment of the invention, upon insertion of a disc into a player, the player reads a disc identification (ID) on the disc. The player then sends a registration request with the disc ID to a server over the Internet for obtaining an authentication key for playing the disc, upon proper registration of the disc by the server. To properly register the disc, the server first determines whether the disc ID is included in its database. Upon proper registration of the disc, the server will set a registration status associated with the disc to prevent any subsequent unauthorized registrations for the same disc. Thus, by using the present invention, unauthorized copying of the disc can be effectively eliminated.

### BACKGROUND OF THE INVENTION

The invention relates to a method and system for authenticating a disc over the Internet.

Copying protection has become an urgent issue to content providers. Each year billions of dollars have been lost by the industry due to piracy. To counter the piracy, various techniques have been proposed such as watermarking, the Contents Scrambling System (CSS), wobble, etc. Digital watermarking is a technique in which watermarks are embedded into audio/video data to indicate whether or not the contents are copyrighted. Watermarks can be easily detected, but can hardly be removed without degrading the content quality. This technique, however, is primarily used for copyright verification, rather than for copying protection. The CSS is a copying protection system developed for protecting against illegal copying of DVD discs. However, it can be easily cracked by software because the CSS uses only 40 bit keys. Wobble is a technique that uses wobble tracks to store the data on a ROM disc, and the wobble is modulated with the copyright information. The contents on such a ROM disc cannot be copied to a recordable disc. This technique is very inflexible since the protection scheme is defined on the physical layer.

Most of the conventional copying protection schemes including those described above are self-contained, i.e., discs with the copying protection schemes need not communicate with the outside world for authentication except with players. As a result, these copying protection schemes are not very effective and can be easily cracked.

Therefore, there is a need for a more effective disc authentication technique that does not rely solely on a copying protection scheme on a disc.

### SUMMARY OF THE INVENTION

The present invention provides a disc player that authenticates a disc via the Internet. According to one embodiment of the invention, upon insertion of a disc into a player, the player reads a disc identification (ID) on the disc. The player then sends a registration request with the disc ID to a server over the Internet for obtaining an authentication key for playing the disc, upon proper registration of the disc by the server. To properly register the disc, the server first determines whether the disc ID is included in its database. If so, the server will then check whether the disc has already been registered. If it has not, the server will send back an encrypted authentication key to the player to enable it to play the disc. Upon proper registration of the disc, the server will set a registration status associated with the disc to prevent any subsequent unauthorized registrations for the same disc. If either the disc ID is not included in the server database or the disc has already been registered, the server will send back a failed registration code to the player that will then reject the disc.

In accordance with the invention, a pre-selected disc may be properly registered for a pre-determined number of times. In such a case, the server will keep track of the number of registrations with respect to that disc. Thus, by using the present invention, unauthorized copying of the disc can be effectively eliminated.

Other objects and attainments together with a fuller understanding of the invention will become apparent and appreciated by referring to the following description and claims taken in conjunction with the accompanying drawings.

### BRIEF DESCRIPTION OF THE DRAWINGS

The invention is explained in further detail, and by way of example, with reference to the accompanying drawings wherein:

FIG. 1 shows an overview of disc copying prevention through Internet authentication in accordance the invention;

FIG. 2 is a simplified diagram illustrating the operation of a disc player in accordance with one embodiment of the invention;

FIG. 3 is a flowchart diagram illustrating a disc registration process performed by a disc player in accordance with one embodiment of the invention; and

FIG. 4 is a flowchart diagram illustrating a disc registration process performed by a web server in accordance with one embodiment of the invention.

Throughout the drawings, the same reference numerals indicate similar or corresponding features or functions.

### DETAILED DESCRIPTION OF THE PREFERRED EMBODIMENTS

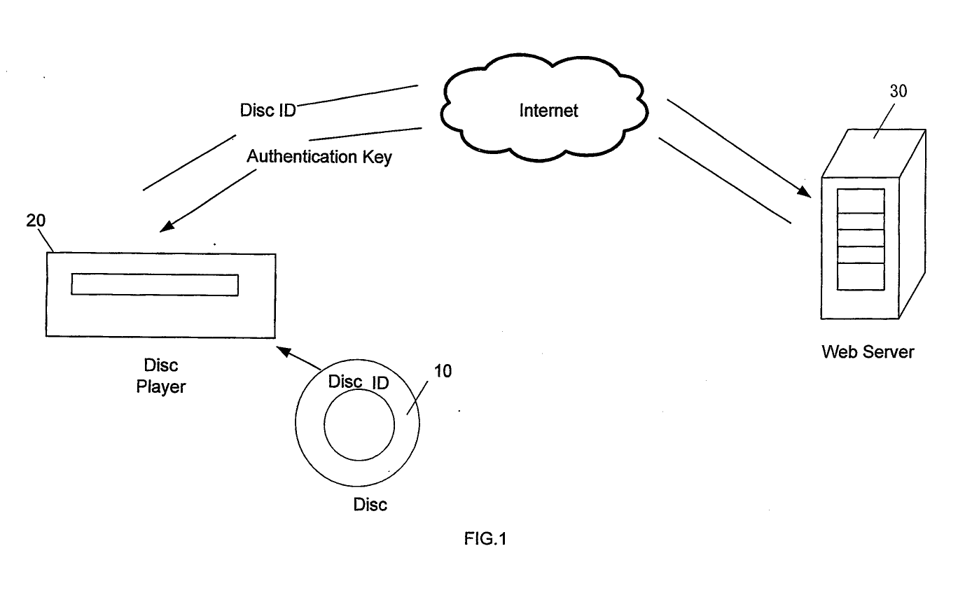

FIG. 1 shows an overview of disc copying prevention through Internet authentication in accordance with the invention. When a new optical disc 10 is inserted into a disc player 20, the player will register the disc by sending an associated unique disc ID to a web server 30 via the Internet. Web server 30 stores a large database maintained by a content provider of the disc, which contains disc IDs for numerous released disc titles. Before the content provider releases a new disc title, all the unique disc IDs associated with this new title will be added to the database, and a registration status associated with each of these unique disc IDs is set to “unregistered”. Upon proper registration of the disc, the web server will send back an authentication key to enable the player to play the disc. In this way, the copyright of the disc is verified.

In accordance with the invention, there are several options to generate and store the disc ID. A first option is to store the disc ID in the Burst Cutting Area (BCA) of a disc. In this way, the disc ID can be scrambled and embedded into a long series of random numbers to confuse hackers, and only the content provider knows how to extract it. A second option is, for each disc in a distribution batch, the content provider can embed the disc ID in a program stream and store the disc ID at a particular location on the disc. The web server knows where to find the disc ID and will fetch the disc ID over the Internet. A third option is to store the disc ID on the clamp area of the disc. In such a case, a read-out device needs to be added to the optical pick-up unit (OPU) of the player in order to read the disc ID on the clamp area.

Once the authentication key is received by the player, it can be used as a decryption key to decrypt the protected contents on the disc. Additionally, in order to protect the information exchanged between the web server and the player from being illegally intercepted or cracked, encryption/decryption measures may be applied to the disc ID and to the authentication key before they are sent out.

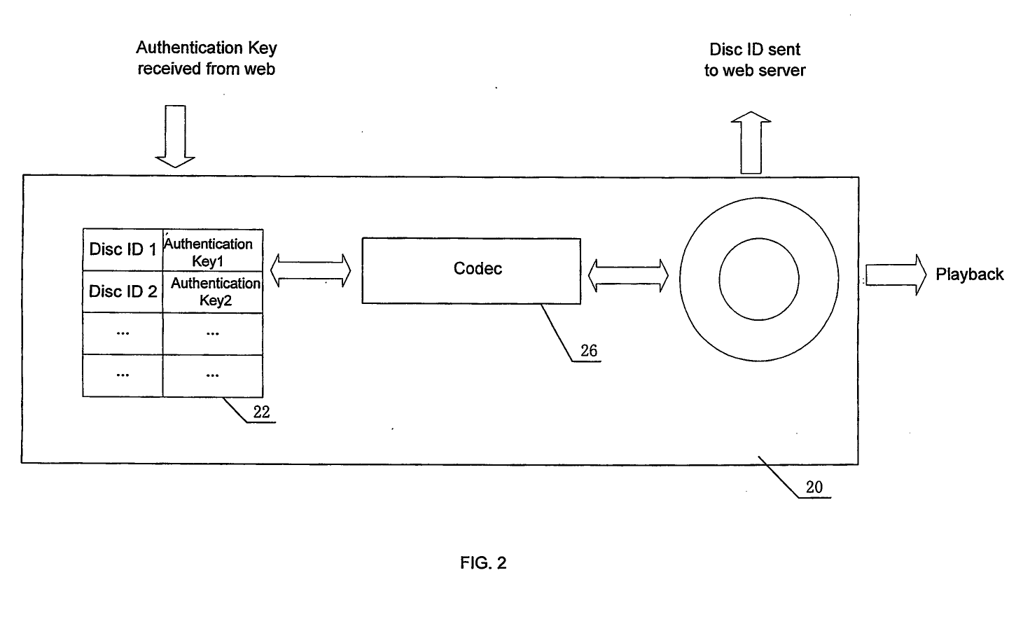

FIG. 2 is a simplified diagram illustrating the operation of a disc player 20 in accordance with one embodiment of the invention. Player 20 may be an operating system independent, stand-alone device with an Internet connection, e.g., a Web DVD player as defined by the DVD Forum, which is an industrial consortium (http://www.dvdforum.org). Player 20 may also be a device in a laptop computer or a desktop PC. Player 20 includes a flash memory 22, which stores encrypted private data of the player including disc IDs and their associated authentication keys, and a codec 26, which decodes the encrypted private data. When disc 10 is played for the first time in player 20, the disc ID is sent to the web server for registration. Upon proper registration, an authentication key is sent back and stored in flash 22 along with the associated disc ID. The authentication key is decoded by codec 26 to enable the player to play disc 10. When disc 10 is subsequently played in player 20, the disc ID will be searched by the player from flash memory 22 to find the associated authentication key. The authentication key will then be retrieved and decoded by codec 26 to enable the player to play disc 10, without requiring further authenticating the disc via the Internet.

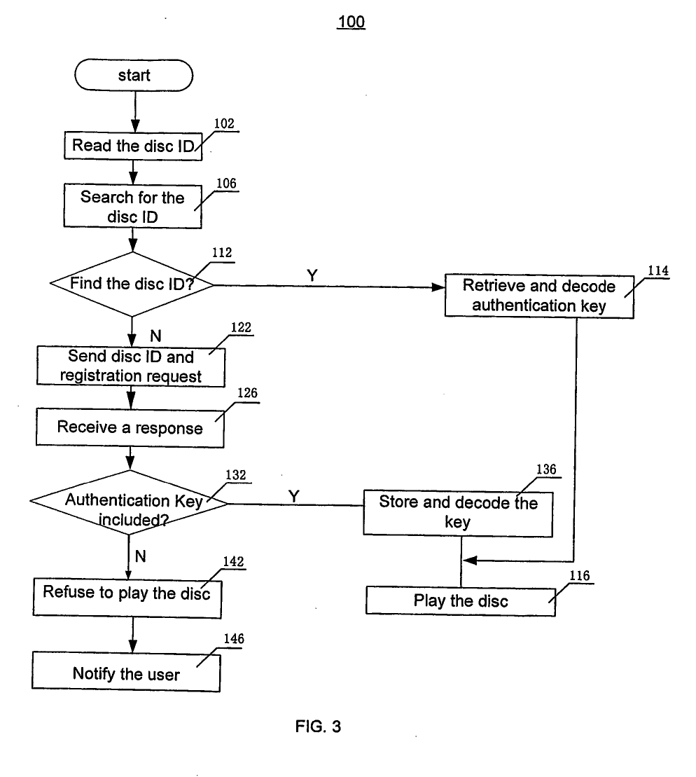

FIG. 3 is a flowchart diagram illustrating a disc registration process 100 performed by the disc player in accordance with one embodiment of the invention. Upon insertion of the disc into the player, the player will read the disc ID (step 102) and search an internal flash memory to find a matching disc ID (steps 106). If a matching disc ID is found, the associated authentication key is retrieved and decoded (step 114), and the player will play the disc (step 116). On the other hand, if a matching disc ID is not included in the flash memory because the disc is played for the first time, the player will send the disc ID and a registration request to a web server (step 122).

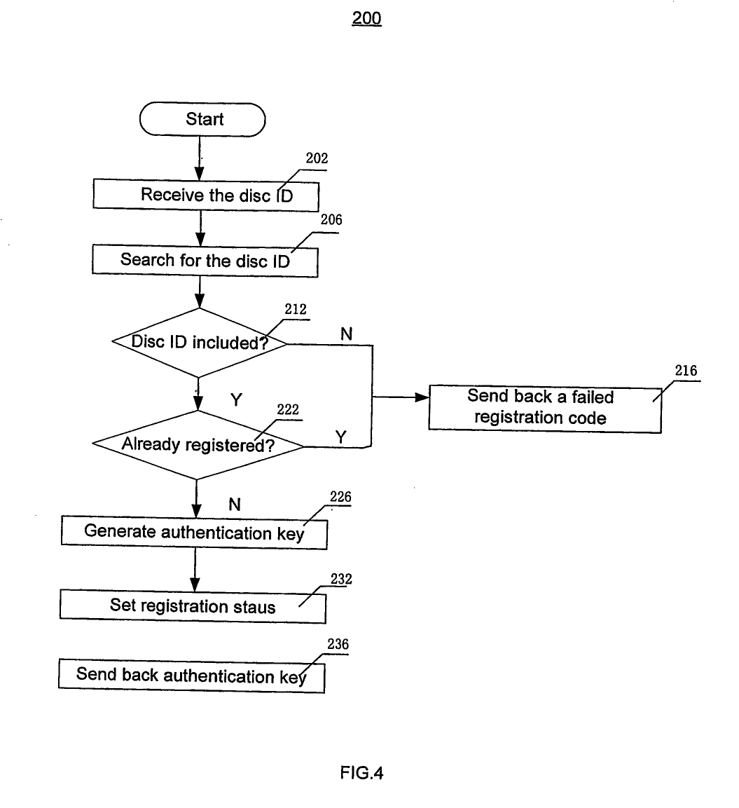

When the web server receives the registration request with the disc ID from the player, it will check, in a disc ID database, a registration status associated with the disc ID received. If the disc ID is included in the database and has not yet been registered, the web server will send back a response with the authentication key to the player. In the meantime, the web server will set the associated registration status to “registered”. On the other hand, if the disc ID is not included in the database or the disc has already been registered, the web server will assume that the disc is not an authentic one and will send back a response to the player without the required authentication key. A more detailed disc registration process performed by the web server will be described below in conjunction with FIG. 4.

In FIG. 3, after receiving a response from the web server (step 126), the player will determine whether the response includes an authentication key (step 132). If the authentication key is included, it will be stored in the player and then decoded (step 136) to enable the player to play the disc (step 116). By storing the authentication key in the player, the disc needs not to be registered again when it is subsequently played. By contrast, if the authentication key is not included in the response received from the web server, the player will refuse to play the disc (step 142), and notify the user (step 146).

FIG. 4 is a flowchart diagram illustrating a disc registration process 200 performed by the web server in accordance with one embodiment of the invention. Upon receiving the disc ID from the player (step 202), the server searches through a database (step 206) to determine whether a matching disc ID is included (step 212). If there is no matching disc ID, the server will send back a failed registration code to the player (step 216). If, however, a matching disc ID is successfully found in the database, the server will next determine whether the disc has already been registered (step 222). If it is already registered, the server will also send back a failed registration code to the player (step 216). On the other hand, if the disc has not yet been registered, the server will generate an authentication key (step 226), set a registration status associated with the disc ID to “registered” (step 232), and send back the authentication key to the player (step 236).

There are two possible ways for a web server to generate authentication keys. In one way, the web server can pre-store authentication keys associated with the pre-defined disc IDs in a database. When it receives a registration request with a legitimate disc ID, it will search for a corresponding authentication key from the database and send it back to the disc player. In another way, when the web server receives a registration request with a disc ID, it will generate a corresponding authentication key by running a software routine and then send it back to the disc player.

In accordance with the invention, content providers may distribute their discs with different editions at different prices. For instance, a disc of home edition may include only one license and can be registered only once with the web server to allow only a specific player to play the disc. On the other hand, a disc of commercial edition may include multiple licenses and can be registered a predetermined number of times with the web server to allow different players to play the disc. This allows a movie rental company to rent a commercial movie title to a specific number of customers. The use of discs with the different editions is monitored by the web server of the content provider. Table 1 illustrates an exemplary format of a disc ID database in the web server. In this table, disc ID1 and disc ID2 each represent a home edition and can be registered only once, while disc ID3 represents a commercial edition and can be registered N times.

TABLE 1
Exemplary format of a disc ID database in the web server

| Disc | Registration | Registration | Registration | | Registration |
|---|---|---|---|---|---|
| ID | Status1 | Status2 | Status3 | . . . | StatusN |
| Disc | Unregistered | n/a | n/a | . . . | n/a |
| ID1 | | | | | |
| Disc | Registered | n/a | n/a | . . . | n/a |
| ID2 | | | | | |
| Disc | Registered | registered | unregistered | . . . | Unregistered |
| ID3 | | | | | |
| . . . | . . . | . . . | . . . | . . . | . . . |
| . . . | . . . | . . . | . . . | . . . | . . . |

While the invention has been described in conjunction with specific embodiments, it is evident that many alternatives, modifications and variations will be apparent to those skilled in the art in light of the foregoing description. Accordingly, it is intended to embrace all such alternatives, modifications and variations as fall within the spirit and scope of the appended claims.

What is claimed is:

1. A player, comprising:
means for reading a disc identification (ID) on a disc;
means for sending a registration request with the disc ID to a server; and
means for receiving an authentication key from the server for playing the disc, upon proper registration of the disc at the server.

2. The player of claim 1, further comprising means for storing the disc ID and the authentication key received from the server.

3. The player of claim 1,
wherein the authentication key is encrypted;
the player further comprising means for decoding the authentication key received.

4. The player of claim 1, further comprising:
a local storage element that stores a database including a plurality of disc IDs; and
means for determining whether the disc ID read from the disc matches one of the disc IDs in the database;
wherein the sending means sends the registration request if the disc ID fails to match any of the disc IDs in the database.

5. The player of claim 4,
wherein the database further includes a plurality of authentication keys corresponding to the plurality of the disc IDs respectively;
the player further comprising means for retrieving a corresponding authentication key from the database for playing the disc if the disc ID matches one of the disc IDs in the database.

6. The player of claim 5,
wherein the authentication keys are encrypted;
the player further comprising means for decoding the authentication keys.

7. The player of claim 1, further comprising means for rejecting the disc if a failed registration code is received from the server.

8. A server for disc registration, comprising:
means for receiving a disc identification (ID) associated with a disc;
means for checking whether the disc ID is included in a database;
means for determining whether the disc has been already registered if the disc ID is included in the database; and
means for generating a corresponding authentication key if the disc ID is included in the database and the disc has not yet been registered.

9. The server of claim 8, further comprising means for setting a registration status associated with the disc ID in the database if the disc ID is included in the database and the disc has not yet been registered.

10. The server of claim 8, further comprising means for providing registration of a pre-selected disc for a pre-determined number of times.

11. The server of claim 10, wherein the receiving means receives a disc ID associated with the pre-selected disc, and wherein the determining means determines whether the pre-selected disc has been registered for the pre-determined number of times.

12. The server of claim 11, further comprising means for setting a corresponding registration status upon each proper registration of the pre-selected disc.

13. The server of claim 8, further comprising:
means for encrypting the authentication key; and
means for sending back the encrypted authentication key.

14. The server of claim 8, further comprising means for sending back a failed registration code if the disc ID is not included in the database.

15. The server of claim 8, further comprising means for sending back a failed registration code if the disc ID is included in the database and the disc is already registered.

16. A disc authentication method, comprising the steps of:
reading a disc identification (ID) on a disc;
sending a registration request with the disc ID to a server; and
receiving an authentication key from the server for playing the disc, upon proper registration of the disc at the server.

17. The method of claim 16, further comprising a step of storing the disc ID and the authentication key received from the server.

18. The method of claim 16,
wherein the authentication key is encrypted;
the method further comprising a step of decoding the authentication key received.

19. The method of claim 16, further comprising:
storing a database including a plurality of disc IDs in a storage element; and
determining whether the disc ID read from the disc matches one of the disc IDs in the database;
wherein the sending step includes a step of sending the registration request if the disc ID fails to match any of the disc IDs in the database.

20. The method of claim 19,
wherein the database further includes a plurality of authentication keys corresponding to the plurality of the disc IDs respectively;
the method further comprising a step of retrieving a corresponding authentication key from the database for playing the disc if the disc ID matches one of the disc IDs in the database.

21. The method of claim 20,
wherein the authentication keys are encrypted;
the method further comprising a step of decoding the authentication keys.

22. The method of claim 16, further comprising a step of rejecting the disc if a failed registration code is received from the server.

23. A disc registration method, comprising the steps of:
receiving a disc identification (ID) associated with a disc;
checking whether the disc ID is included in a database;
determining whether the disc has been already registered if the disc ID is included in the database; and
generating a corresponding authentication key if the disc ID is included in the database and the disc has not yet been registered.

24. The method of claim 23, further comprising a step of setting a registration status associated with the disc ID in the database if the disc ID is included in the database and the disc has not yet been registered.

25. The method of claim 23, further comprising a step of providing registration of a pre-selected disc for a pre-determined number of times.

26. The method of claim 25, wherein the receiving step includes a step of receiving a disc ID associated with the pre-selected disc, and wherein the determining step includes a step of determining whether the pre-selected disc has been registered for the pre-determined number of times.

27. The method of claim 26, further comprising a step of setting a corresponding registration status upon each proper registration of the pre-selected disc.

28. The method of claim 23, further comprising:
encrypting the authentication key; and
sending back the authentication key.

29. The method of claim 23, further comprising a step of sending back a failed registration code if the disc ID is not included in the database.

30. The method of claim 23, further comprising a step of sending back a failed registration code if the disc ID is included in the database and the disc is already registered.
